(19) United States
(12) Patent Application Publication
(10) Pub. No.: US 2014/0227650 A1
(43) Pub. Date: Aug. 14, 2014

(54) Container for candles, with internal circulation of air

(71) Applicant: Andrzej Wrobel, Wielun (PL)

(72) Inventor: Andrzej Wrobel, Wielun (PL)

(21) Appl. No.: 14/236,850

(22) PCT Filed: Jul. 6, 2012
(86) PCT No.: PCT/PL2012/000052

§ 371 Date: Apr. 27, 2014

(30) Foreign Application Priority Data
Jul. 6, 2011 (PL) P.395541

(51) Int. Cl. F21V 37/00; F21V 37/02; F21V 35/00

(52) U.S. Cl. CPC F21V 37/0095; F21V 35/00; F21V 37/02
USPC 431/291

(57) ABSTRACT

The container for candles with internal circulation of air has an external casing (1) and an internal casing (2) with ventilating holes, respectively (4) and (3) which ensure circulation of air between the casings.

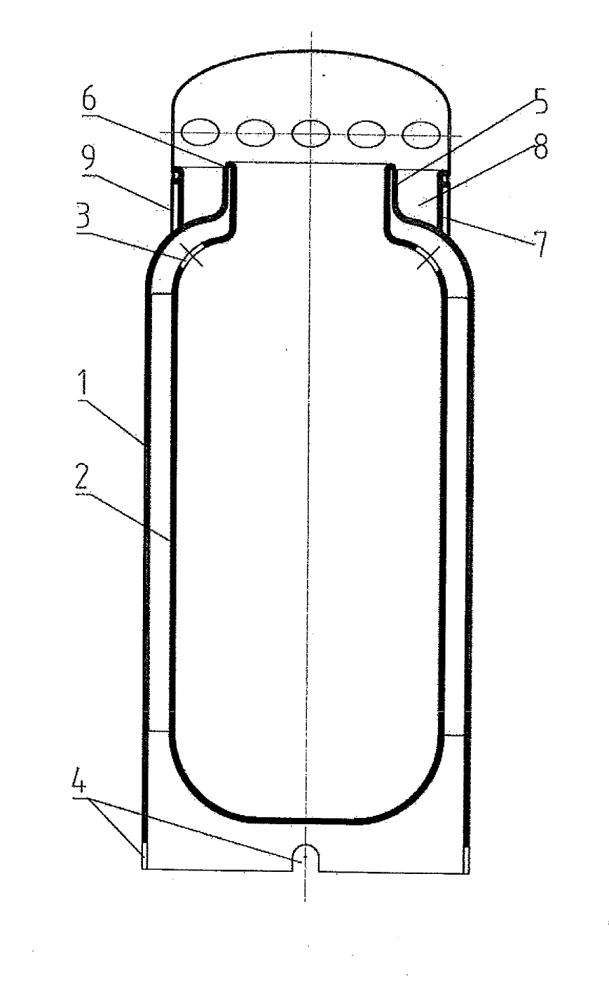

The subject-matter of the invention is a container with internal circulation of air for candles, cemetery lamps or oils.

There are containers for candles used for cemetery lamps in which a candle in a plastic tube is put into an external casing of decorative shape. Between the tube with the candle and the external casing a large space is formed, which is not filled with a combustible.

There are also glass containers which resemble a glass with candles put inside. The casings make it possible for a candle to burn continuously, but after it has burnt out the casing gets dirty. Before putting a new candle into the casing, the residue needs to be removed, which is difficult. There is also a Polish patent No. 326577 for the invention of a cemetery lamp with two candle wicks and with a funnel which is tightly fitted to a hole in an external casing. As a result, between them a cushion of air is generated which insulates flames from changing weather. These solutions do not guarantee even burning of combustible mixture inside the casings.

The container for candles, according to the patent, has an external casing with ventilating holes and an internal casing with ventilating holes. But the external casing has a cylinder and a collar with a canal in between. The collar of the internal casing is fitted on the cylinder.

The subject-matter of the patent is presented in the horizontal section picture.

The container for candles, according to the patent, has an external casing 1 with four ventilating holes 4 at the bottom. The internal casing 2 has ventilating holes in the upper part 3. The ventilating holes 3 and 4 ensure free circulation of air between the space inside the internal casing 2 and air outside.

The collar 6 of the internal casing 2 is fitted on the cylinder 5 of the external casing. The external casing 1 has a collar 7 with a cover 9 at the top. Between the cylinder 5 and the collar 7 there is a canal 8, which stops raindrops or other residue which may get inside through the ventilating holes in the cover 9—providing that there are such holes, because within the proposed patent a cover without ventilating holes can also be used. Free circulation of air between the casings ensures even and efficient burning of the combustible mixture inside the internal casing 2.

The container's structure, according to the description above, ensures efficient burning also because the air circulating between the casings 1 and 2 gets warm in an initial phase.

1. The container for candles with internal circulation of air which has an external as well as internal casing filled with a combustible with a candle wick and which has a cover is distinguished by the fact that the external casing (1) has ventilating holes (4) and the internal casing (2) has ventilating holes (3) but the external casing (1) is equipped with a cylinder (5) and collar (7) which form in between a canal (8) with the reservation that the collar (6) of the internal casing (2) is fitted on the cylinder (5).
